(19) United States
(12) Patent Application Publication
(10) Pub. No.: US 2016/0018945 A1
(43) Pub. Date: Jan. 21, 2016

(54) HEURISTIC PALM DETECTION

(71) Applicant: Prime Circa, Inc., Lakeville, MN (US)

(72) Inventors: Viet Tran, Irvine, CA (US); Khoa Hong, Ho Chi Minh City (VN); Xuyen Tran, Ho Chi Minh City (VN)

(21) Appl. No.: 14/799,160

(22) Filed: Jul. 14, 2015

Related U.S. Application Data
(60) Provisional application No. 62/025,680, filed on Jul. 17, 2014.

(51) Int. Cl. G06F 3/041; G06F 3/0488

(52) U.S. Cl. CPC G06F 3/0418; G06F 3/04883

(57) ABSTRACT

Method for detecting touches on a multi-touch interface comprising of receiving information relating to a first touch and information relating to one or more other touches through a touch-based display. The method further comprising performing a touch analysis, the analysis being a comparison of the first touch as compared to the one or more other touches in order to determine a writing touch and one or more non-writing touches. The analysis including an influence score component for performing a distance based comparison of the first touch to the one or more other touches, the comparison determining an influence score between the first touch and each of the one or more other touches. The analysis also including an impact score component for determining an impact score for each touch, the impact score based on the one or more influence scores between the first touch and the one or more other touches.

### CROSS REFERENCE TO RELATED APPLICATIONS

The present application claims priority to U.S. Provisional Patent Application No. 62/025,680 filed on Jul. 17, 2014, the content of which is hereby incorporated by reference herein in its entirety.

### FIELD OF THE INVENTION

The present disclosure relates to handwriting on a multi-touch screen. More particularly, the present disclosure relates to identifying the touches intended to be recorded and recording only those touches. Specifically, the present disclosure relates to recognizing and rejecting the unintentional touches registered by the user while handwriting.

### BACKGROUND OF THE INVENTION

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Multi-touch interfaces or screens are increasingly common and used to interact with everything from our phone, tablet, and/or computer to our car, refrigerator, or television. The advantages of using a multi-touch screen have allowed for great advancement in productivity but have also helped users become increasingly environmentally friendly, as people increasingly use electronic correspondence instead of requiring paper. However, the multi-touch screens have been limited in usefulness to those who wish to use them to free-form draw or handwrite. In particular, because the touch screens are capable of registering both the intentional touches used to write or draw and the plurality of unintentional touches made by a user's hand or otherwise, multiple unintentional markings may be made. This may be especially true when a user rests part of his/her palm or hand on the multi-touch surface when writing, as one typically does when writing on paper. Accordingly, there is a need in the art for a system or method of differentiating between the intentional touches used to write and the unintentional touches made on the surface of a multi-touch interface. Particularly, there is a need for systems or methods that identify the intentional writing touches, and record and display them on the multi-touch screen, while also identifying unintentional touches and discarding or ignoring them.

### BRIEF SUMMARY OF THE INVENTION

The following presents a simplified summary of one or more embodiments of the present disclosure in order to provide a basic understanding of such embodiments. This summary is not an extensive overview of all contemplated embodiments, and is intended to neither identify key or critical elements of all embodiments, nor delineate the scope of any or all embodiments.

The present disclosure, in one embodiment, relates to a method for detecting touches on a multi-touch interface. The method may include receiving information relating to a first touch and receiving information relating to one or more other touches through a touch-based display screen; performing a touch analysis, the touch analysis being a comparison of the first touch as compared to the one or more other touches in order to determine a writing touch and one or more non-writing touches, the touch analysis comprising determining a distance-based influence score between the first touch and each of the one or more other touches. In certain embodiments, each touch may have a touch-start event, a touch-move event, and a touch-end event, wherein the touch-start event relates to a point of first contact of the touch with the touch-based display screen, the touch-move event relates to a path of movement of the touch while it remains in contact with the touch-based display screen, and the touch-end event relates to a last point of contact of the touch before losing contact with the touch-based display screen. The influence score between the first touch and each of the one or more other touches may be specifically determined from the expression: f(d, t)=(1−min(d, dₘₐₓ)/dₘₐₓ)²*(1−min(t, tₘₐₓ)/tₘₐₓ)², where d is the distance from the respective other touch to the location of the first touch, dmax is the maximum distance within which the respective other touch may have an influence on the first touch, t is the time since the respective other touch ended; and tmax is the maximum time that the respective other touch may influence other touches after it has ended. In some embodiments, dmax and tmax may be predetermined values. In some embodiments, the influence score for the first touch may be determined at the touch-start event, at the touch-end event, and/or at least once during the touch-move event. In still further embodiments, the influence score for the first touch may be determined periodically during the touch-move event. In certain embodiments, the touch analysis may further include determining an impact score for the first touch, the impact score based on the one or more influence scores of the first touch. In even further embodiments, the touch analysis may include determining, for each touch, a distance-based influence score between that touch and each of the other touches, and may additionally include determining an impact score for each touch, the impact score based on the one or more influence scores of the respective touch. The impact score for each touch may be a sum of the one or more influence scores determined for that touch. The touch analysis may determine the writing touch and one or more non-writing touches based on the impact scores of the touches. In some embodiments, the writing touch may be the touch with the lowest impact score. In additional embodiments, the touch analysis may utilize a threshold value, where touches with an impact score on one side of the threshold cannot be considered a writing touch irrespective of a comparison of their impact scores to the impact scores of other touches. In some embodiments, an impact score for a touch may be modified based on at least one of a position of the touch on the touch-based display screen and a direction of movement of the touch on the touch-based display screen. In still further embodiments, the touch analysis may include determining, for each of the non-writing touches, a vector with a direction toward the writing touch and a magnitude based on a comparison of that touch's impact score and the impact score of the writing touch. The magnitude of a vector for each non-writing touch may be based on the difference between the impact score of the respective non-writing touch and the impact score of the writing touch. The touch analysis may determine a writing style confidence vector based on a mathematical combination of the vectors for each non-writing touch, where the writing style confidence vector may indicate a given writing style. In some embodiments, the touch analysis may re-determine the writing touch and one or more non-writing touches based on the writing style confidence vector.

While multiple embodiments are disclosed, still other embodiments of the present disclosure will become apparent to those skilled in the art from the following detailed description, which shows and describes illustrative embodiments of the invention. As will be realized, the various embodiments of the present disclosure are capable of modifications in various obvious aspects, all without departing from the spirit and scope of the present disclosure. Accordingly, the drawings and detailed description are to be regarded as illustrative in nature and not restrictive.

### BRIEF DESCRIPTION OF THE DRAWINGS

While the specification concludes with claims particularly pointing out and distinctly claiming the subject matter that is regarded as forming the various embodiments of the present disclosure, it is believed that the invention will be better understood from the following description taken in conjunction with the accompanying Figures, in which:

FIG. 1 is a schematic of a user writing on a multi-touch interface, in accordance with an embodiment of the present disclosure.

FIG. 2 is a graphical representation of example touch-based strokes recognized by the multi-touch interface, in accordance with an embodiment of the present disclosure.

FIG. 3 is another graphical representation of example touch-based strokes recognized by the multi-touch interface, in accordance with an embodiment of the present disclosure.

FIG. 4 is still another graphical representation of example touch-based strokes recognized by the multi-touch interface, in accordance with an embodiment of the present disclosure.

FIG. 5 is a graphical representation of sample hand writing styles, in accordance with an embodiment of the present disclosure.

FIG. 6 is a graphical representation of example touch-based strokes recognized by the multi-touch interface illustrating the impact score's magnitude and direction on a touch point, in accordance with an embodiment of the present disclosure.

FIG. 7 is a flowchart illustrating the method to identify the writing touch, in accordance with an embodiment of the present disclosure.

### DETAILED DESCRIPTION

The present disclosure relates to novel and advantageous ways to identify and distinguish between different touches made on a multi-touch screen or interface. Particularly, the present disclosure relates to novel and advantageous ways to detect and reject unintentional touches made while, for example, handwriting on a multi-touch screen or interface.

For purposes of this disclosure, any system described herein may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, a system or any portion thereof may be a personal computer (e.g., desktop or laptop), tablet computer, mobile device (e.g., personal digital assistant (PDA) or smart phone), server (e.g., blade server or rack server), a network storage device, or any other suitable device or combination of devices and may vary in size, shape, performance, functionality, and price. A system may include random access memory (RAM), one or more processing resources such as a central processing unit (CPU) or hardware or software control logic, ROM, and/or other types of nonvolatile memory. Additional components of a system may include one or more disk drives or one or more mass storage devices, one or more network ports for communicating with external devices as well as various input and output (I/O) devices, such as a keyboard, a mouse, touchscreen and/or a video display. Mass storage devices may include, but are not limited to, a hard disk drive, floppy disk drive, CD-ROM drive, smart drive, flash drive, or other types of non-volatile data storage, a plurality of storage devices, or any combination of storage devices. A system may include what is referred to as a user interface, which may generally include a display, mouse or other cursor control device, keyboard, button, touchpad, touch screen, microphone, camera, video recorder, speaker, LED, light, joystick, switch, buzzer, bell, and/or other user input/output device for communicating with one or more users or for entering information into the system. Output devices may include any type of device for presenting information to a user, including but not limited to, a computer monitor, flat-screen display, or other visual display, a printer, and/or speakers or any other device for providing information in audio form, such as a telephone, a plurality of output devices, or any combination of output devices. A system may also include one or more buses operable to transmit communications between the various hardware components.

One or more programs or applications, such as a web browser, and/or other applications may be stored in one or more of the system data storage devices. Programs or applications may be loaded in part or in whole into a main memory or processor during execution by the processor. One or more processors may execute applications or programs to run systems or methods of the present disclosure, or portions thereof, stored as executable programs or program code in the memory, or received from the Internet or other network. Any commercial or freeware web browser or other application capable of retrieving content from a network and displaying pages or screens may be used. In some embodiments, a customized application may be used to access, display, and update information.

Hardware and software components of the present disclosure, as discussed herein, may be integral portions of a single computer or server or may be connected parts of a computer network. The hardware and software components may be located within a single location or, in other embodiments, portions of the hardware and software components may be divided among a plurality of locations and connected directly or through a global computer information network, such as the Internet.

As will be appreciated by one of skill in the art, the various embodiments of the present disclosure may be embodied as a method (including, for example, a computer-implemented process, a business process, and/or any other process), apparatus (including, for example, a system, machine, device, computer program product, and/or the like), or a combination of the foregoing. Accordingly, embodiments of the present disclosure may take the form of an entirely hardware embodiment, an entirely software embodiment (including firmware, middleware, microcode, hardware description languages, etc.), or an embodiment combining software and hardware aspects. Furthermore, embodiments of the present disclosure may take the form of a computer program product on a computer-readable medium or computer-readable storage medium, having computer-executable program code embodied in the medium, that define processes or methods described herein. A processor or processors may perform the necessary tasks defined by the computer-executable program code. Computer-executable program code for carrying out operations of embodiments of the present disclosure may be written in an object oriented, scripted or unscripted programming language such as Java, Perl, PHP, Visual Basic, Smalltalk, C++, or the like. However, the computer program code for carrying out operations of embodiments of the present disclosure may also be written in conventional procedural programming languages, such as the C programming language or similar programming languages. A code segment may represent a procedure, a function, a subprogram, a program, a routine, a subroutine, a module, an object, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

In the context of this document, a computer readable medium may be any medium that can contain, store, communicate, or transport the program for use by or in connection with the systems disclosed herein. The computer-executable program code may be transmitted using any appropriate medium, including but not limited to the Internet, optical fiber cable, radio frequency (RF) signals or other wireless signals, or other mediums. The computer readable medium may be, for example but is not limited to, an electronic, magnetic, optical, electromagnetic, infrared, or semiconductor system, apparatus, or device. More specific examples of suitable computer readable medium include, but are not limited to, an electrical connection having one or more wires or a tangible storage medium such as a portable computer diskette, a hard disk, a random access memory (RAM), a read-only memory (ROM), an erasable programmable read-only memory (EPROM or Flash memory), a compact disc read-only memory (CD-ROM, or other optical or magnetic storage device. Computer-readable media includes, but is not to be confused with, computer-readable storage medium, which is intended to cover all physical, non-transitory, or similar embodiments of computer-readable media.

Various embodiments of the present disclosure may be described herein with reference to flowchart illustrations and/or block diagrams of methods, apparatus (systems), and computer program products. It is understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks. Alternatively, computer program implemented steps or acts may be combined with operator or human implemented steps or acts in order to carry out an embodiment of the invention.

Additionally, although a flowchart may illustrate a method as a sequential process, many of the operations in the flowcharts illustrated herein can be performed in parallel or concurrently. In addition, the order of the method steps illustrated in a flowchart may be rearranged for some embodiments. Similarly, a method illustrated in a flow chart could have additional steps not included therein or fewer steps than those shown. A method step may correspond to a method, a function, a procedure, a subroutine, a subprogram, etc.

As used herein, the terms “substantially” or “generally” refer to the complete or nearly complete extent or degree of an action, characteristic, property, state, structure, item, or result. For example, an object that is “substantially” or “generally” enclosed would mean that the object is either completely enclosed or nearly completely enclosed. The exact allowable degree of deviation from absolute completeness may in some cases depend on the specific context. However, generally speaking, the nearness of completion will be so as to have generally the same overall result as if absolute and total completion were obtained. The use of “substantially” or “generally” is equally applicable when used in a negative connotation to refer to the complete or near complete lack of an action, characteristic, property, state, structure, item, or result. For example, an element, combination, embodiment, or composition that is “substantially free of” or “generally free of” an ingredient or element may still actually contain such item as long as there is generally no measurable effect thereof.

Generally, the various embodiments of the present disclosure permit free-form writing or drawing on a multi-touch screen by disregarding or canceling the recording and resulting display of unintentional inputs made by a user's hand. As discussed above, when writing on a touch screen there may be a plurality of touches registered including one or more unintentional touches caused, for example, by the user's palm hitting the touch screen. A writing touch may generally refer to the touch which registers the finger, stylus, magnetized device, or other writing instrument (herein collectively and interchangeably referred to as a writing tool or writing tools) that is used to write or draw on the touch screen. In contrast, a palm touch as used herein, despite the name, may generally and collectively refer to any touch that is unintentionally registered because a part of the hand or other object comes into contact with the multi-touch screen while writing. Various embodiments of the present disclosure may differentiate between a writing touch and one or more palm touches. The registered palm touches may be discarded or ignored, thereby substantially recording only intentional writing touches, in various embodiments. The recorded writing touches may generally render lines, shapes, or other drawing marks made by a writing tool to appear generally the same as or similar to those same lines, shapes, or other drawing marks would appear utilizing a real-life version of the utensil on a physical medium, such as a pen on paper. The various embodiments of the present disclosure may be particularly useful with, although are not limited to use with, handheld electronic processing devices, such as portable computers (e.g., laptop), mobile tablet devices, and smartphones having touch-screen capabilities activated by touch.

In order to accomplish the described handwriting, the various embodiments of the present invention may employ one or more modules or interfaces for receiving free-form input, taking account of one or more observed assumptions, performing a touch influence analysis, performing a vector analysis, and rendering a graphical image representative of what is perceived to be the intentional input or touch. The various example modules or interfaces may be provided as hardware and/or software components, and in one embodiment may be provided as a web-based application, a mobile app, or an application that runs in the background while one or more other applications are in use. Certain modules or interfaces may be configured for use with generally any electronic or other processing device, and may particularly be configured for access from, or download and use from, a mobile device, such as but not limited to a smartphone, tablet device, and the like, in conventional manners, such as by access through a web browser or by download and install from an “app store.” The various example modules or interfaces of the present disclosure may be utilized as a stand-alone application. However, in many embodiments, the various example modules or interfaces of the present disclosure may be utilized by, accessed by, incorporated into, etc., any suitable end product utilizing graphics, such as but not limited to, a drawing application, note-taking application, word processing application, or other productivity application, etc. in order to provide the desired electronic handwritings.

The various embodiments of the present disclosure may include or be communicatively coupled with an input module for receiving input strokes from a user, such as input touch-based strokes from a user. As described above, the various embodiments of the present disclosure may be particularly useful with, although are not limited to use with, electronic processing devices, such as computers, desktop or laptop, mobile tablet devices, and smartphones having touch-screen capabilities activated by touch via, for example, a user's finger(s) or a stylus or other like device. Accordingly, the various embodiments of the present disclosure may employ existing hardware and/or software components, such as a touch screen, processor, etc., of such devices to receive and (initially) process touch-based input from the user. In other embodiments, appropriate hardware and/or software components, such as any of those described in detail above, may be specifically designed and configured for receiving and processing a user's touch-based input and preparing the input data for other modules of the present disclosure, described in further detail below.

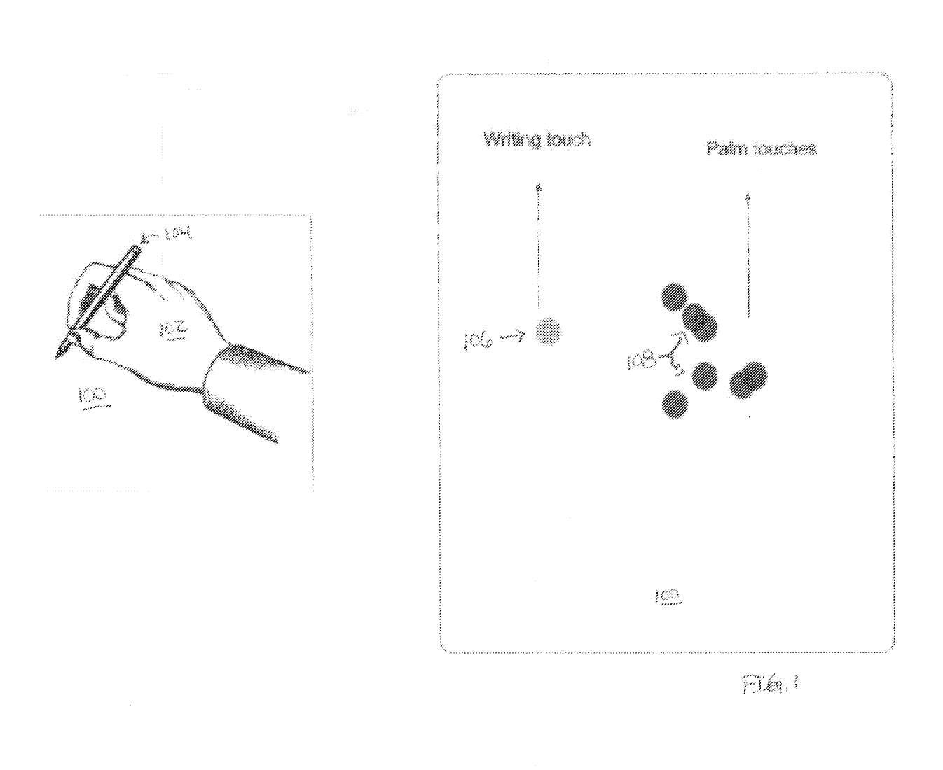

While the input module may initially receive and process user touches, one or more of such touches may be unintentionally made on a multi-touch interface. As seen in FIG. 1, for example, a user's hand 102 may rest on the surface of the multi-touch interface 100 as the user writes or draws. The writing tool 104 may touch the surface 100 with the intent to make a mark. The multi-touch interface 100 may register the touch 106 made by the writing tool 104. The touch 106 may herein be referred to as a writing touch 106. However, because the interface 100 may recognize multiple touches simultaneously, it may also undesirably register one or more touches 108 made by the palm or hand 102 resting on the surface 100.

In one embodiment, a writing touch module may be provided for determining and/or differentiating which touch is the writing touch and which touch(es) are the palm touch(es). The writing touch module may be predicated on one or more assumptions and use one or more components to determine what category each touch should be recognized as. In order to distinguish between the writing touch, which may be recorded and displayed, and the one or more palm touches, which may be ignored or discarded, the present disclosure may use one or more assumptions, one or more algorithms, one or more logical rules or any other suitable method. Furthermore, in order to distinguish between the writing touch and the one or more palm touches, the writing touch module may include, but is not limited to including, an influence score component, an impact score component, a threshold component, a distance comparison component, and/or a writing style component.

In various embodiments, the ability to distinguish and reject palm touches from writing touches may be based on one or more assumptions. Assumptions may be based on observations of how a person generally writes, for example and example only, the position of the hand during writing. As previously mentioned, many people rest a portion of their hand on the surface as they write. The portion of the hand that comes in contact with the surface generally leads to a plurality of palm touches being registered at any given time. Thus, one assumption is that more than one palm touch may be recognized by the interface at a time. In other embodiments, however, only one palm touch may be registered. Nonetheless, using one or more features disclosed herein, the writing touch may still be distinguishable from any registered palm touch.

Conversely, a person generally writes with only one instrument at a time. This leads to the second assumption, that there may be only one writing touch. In other embodiments, however, more than one writing touch may be registered. Typically, though, the writing touches may still be focused on one general location, and thus the second assumption may then be that writing touches are grouped closer together than palm touches. In at least one embodiment, if the touches are grouped close enough, they may be recognized as one touch.

Whether using a finger, stylus, or other instrument, the writing tool is usually extended in some direction from the rest of the hand or palm. This gives rise to a third assumption, that palm touches may be close, in relative proximity, to each other. An implication of this assumption is that writing touches may not be close in proximity to other touches. In various embodiments, this assumption may be highly effective in detecting palm touches, as discussed below.

Like assumption three, but in reverse, a fourth assumption may be that a palm touch is farther away from a writing touch than from other palm touches. That is, the distance from a given palm touch to the writing touch will generally be greater than the distance from the given palm touch to another palm touch. In various embodiments, this assumption may be used to help detect a writing touch.

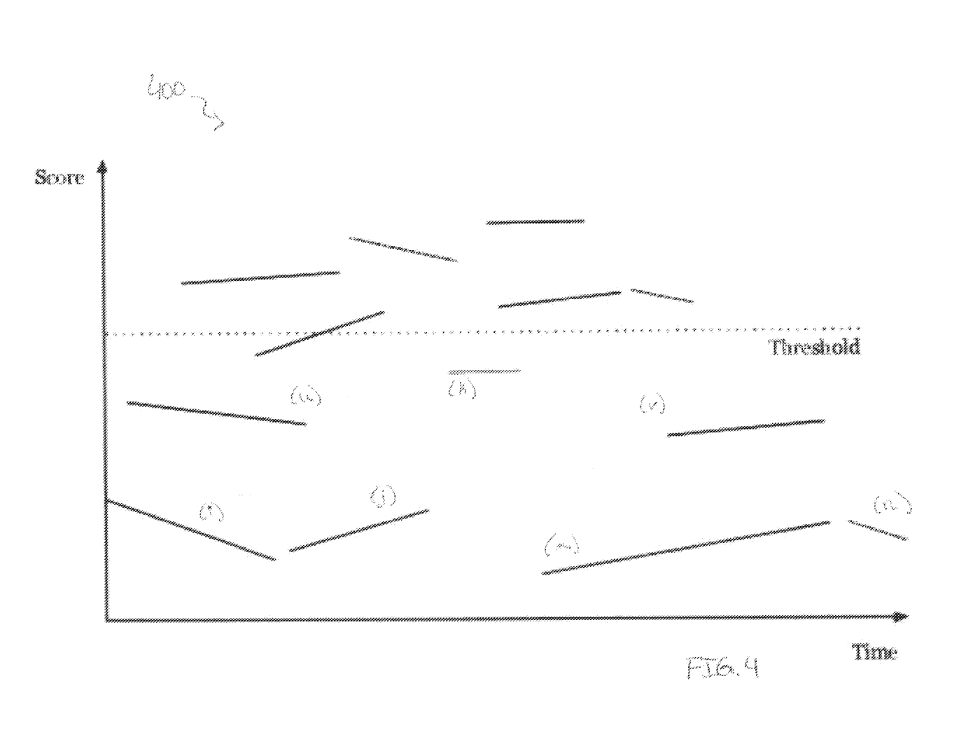

Further yet, people generally rest their hand on the writing surface before they begin to write. In addition, between strokes there is no registered writing touch. Thus, if applying only the above assumptions, a distal palm touch may be falsely identified as a writing touch, thereby leaving a mark on the page. This gives rise to a fifth assumption, that a writing touch may not generally move quickly from a writing location to a palm location, or vice versa. That is, writing touches may generally remain in the same relative area, away from the palm touches. A touch that is recognized as being suddenly and relatively closer to the registered palm touches, as compared to previous touches, may be discarded as a palm touch. This will be explained in greater detail in reference to FIG. 4, discussed herein.

Similar to the above observation, people generally write using strokes. Whether constructing a single letter or symbol or using one stroke to construct an entire word (as in cursive writing), a person generally lifts the writing tool from the surface for at least a measurable period of time. Thus, a sixth assumption is that a touch, or touch-based stroke, has a life span. That is, a touch has a touch-start event, a touch-move event, and a touch-end event. A touch-start event may be defined as the point where a writing tool first makes contact with the surface. A touch-move event may register the life of the stroke, or the movements in all directions the writing tool makes while it remains in contact with the surface. A touch-end event may be defined as the last point a writing tool registers before losing contact with the surface.

The above defined assumptions may be used alone or in combinations of one or more to detect the different types of registered touches; recording the writing touches and rejecting or disregarding the palm touches. That is, the registered touches that are deemed to be the writing touches may be recorded and become visible to the user of the multi-touch interface whereas the registered touches that are deemed palm touches may be ignored. In various embodiments, one or more of the six assumptions may be utilized to accomplish the palm detection objective. In other embodiments, additional or alternative assumptions may be used.

In general, the writing touch module may analyze each registered touch. In various embodiments, the touches may be analyzed using one or more algorithms. That is, one or more characteristics of the touch may be registered and an algorithm may be used to calculate a score for the touch. Any function or algorithm to calculate a score may be used, and of course may be based on a variety of factors and/or assumptions, such as but not limited to, the user's electronic device capabilities or other characteristics, the device operating system, the distance of one or more touches from one or more other locations, the timing of when a touch was made, scores or characteristics pre-determined about one or more touches, any one or more of the assumptions identified above, etc. The score or multiple scores for several touches may be used to differentiate between the writing touch and the palm touches.

In one embodiment, an influence score component may be used to calculate an influence score for at least one, but typically each, touch point. In some embodiments, the influence score may be primarily based on assumptions three, four, and five, however, the invention need not be so limited. The influence score may generally represent an influence, or effect, of one touch to another touch, measured as a function. In some embodiments, the function may be based on the distance from one touch to the location of another touch. In one embodiment, a farther distance may correspond to a lower score. It is recognized however, that in other embodiments, a farther distance may correspond to a higher score, depending on the algorithm. The function may additionally or alternatively be based on the time period between the touch-end event of one or more touches until the time that such influence is determined. In one embodiment, a longer period of time may lower the score. It is recognized however, that in other embodiments, a longer period of time could conversely increase the score, depending on the algorithm. It may be appreciated that the function may be based on any influencing measurement and that the measurement of that influence may be scored relatively higher or lower depending on the algorithm used or outcome desired.

In one particular embodiment, the algorithm for determining or calculating the influence score on a first touch point may be determined using the following expression:

f(d, t)=(1−min(d, dₘₐₓ)/dₘₐₓ)²*(1−min)(t, tₘₐₓ)/tₘₐₓ)²

where d is the distance from a second touch to the location of the first touch, which is the touch for which the influence is being calculated; d,ₘₐₓ is the maximum distance within which the second touch may have an influence on the first touch; t may be the time since the second touch ended; and tₘₐₓ may be the maximum time that the second touch may influence other touches after it has ended. As should be appreciated, if d is greater than dₘₐₓ, the influence score may be zero. Likewise, if t is greater than tₘₐₓ, the influence score may be zero. In one embodiment, dₘₐₓ may be pre-determined. In another embodiment, dₘₐₓ may be set by the user. In still another embodiment, dₘₐₓ may be dynamic and therefore may vary, for example in substantially or nearly real time, depending on the writing style(s) of the user(s). In one embodiment, tₘₐₓ may be pre-determined. In another embodiment, tₘₐₓ may be set by the user. In still another embodiment, tₘₐₓ may be dynamic and therefore may vary, for example in real time, depending on the writing style(s) of the user(s). Generally, in one embodiment, the influence score on a first touch by a second touch may be measured, where the second touch is less than the maximum distance (dₘₐₓ) from the first touch and made within the allotted time since the second touch ended, as measured by the maximum time (tₘₐₓ).

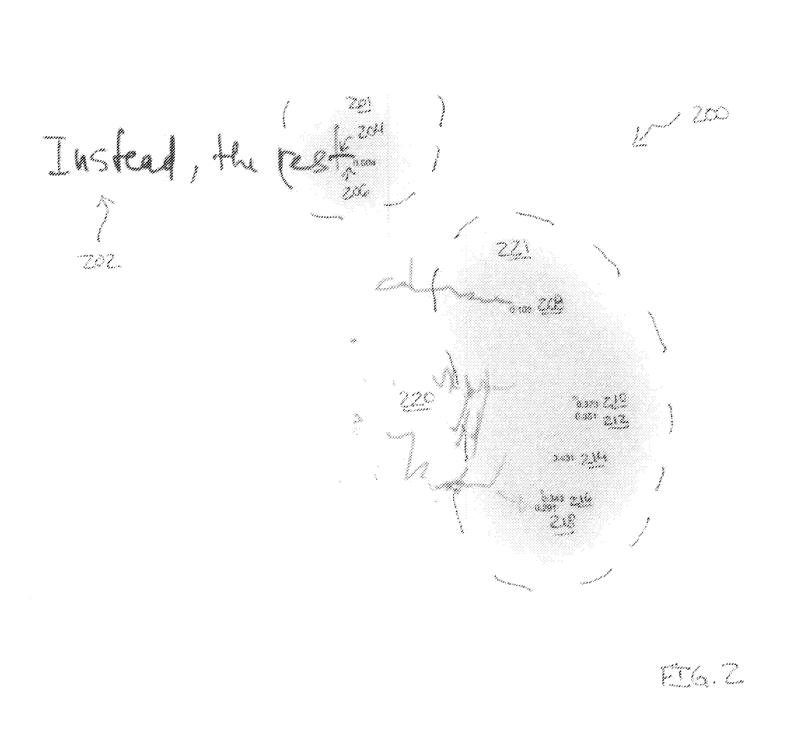

An influence score may be calculated at various times during a handwriting, including but not limited to the moment the touch is registered, periodically after each stroke, during each stroke, at predetermined intervals, at the end of a touch, randomly, and/or other methods. An influence score may be calculated substantially continuously or sporadically. Referencing FIG. 2, the multi-touch interface 200 shows an example handwriting 202. In this example, the last handwriting stroke 204 is the cross on the letter “t” of “rest.” For purposes of discussion only, the stroke's 204 touch-end event may create a final writing touch 206, which may be used to calculate an influence score, in some embodiments. It should be appreciated that an influence score may additionally or alternatively be calculated at any time during the lifespan of handwriting stroke 204, as discussed above. That is, any point or point(s) along the touch-based stroke 204 may be generally used to calculate an influence score for the stroke 204. The dotted lines 201 may show, generally, the location of the writing tool at the time of the last handwriting stroke. The previous writing touches may be recorded and displayed as the first part of the phrase “Instead, the rest,” excluding the cross on the letter “t.” The dotted lines 221 may show, generally, the location of the palm, or hand at the time of the last handwriting stroke. The palm touches 220, shown for demonstrative purposes, highlight the touches registered on the multi-touch interface 200 as the palm or hand was dragged across the surface as the handwriting 202 commenced.

As discussed above, an influence score may be measured, or calculated, between any two touch points. For example, an influence score may be measured between the writing touch 206 and the palm touch 208. For purposes of illustration only, the writing touch 206 may be considered the first touch while the palm touch 208 may be considered the second touch; other than that, the designations of first and second do not denote any sort of order or preference. Using the example formula above, the distance between the touch points, as well as the time since the second touch ended, may be input into the equation and an influence score for writing touch 206 may be determined. The outputted influence score may reflect the influence the palm touch 208 has on the writing touch 206. The equation may also be used where the palm touch 208 is the first touch and the writing touch 206 is the second touch to determine an influence score for palm touch 208. In some embodiments, the algorithm may result in the same influence score value for any given two touch points, the two touch points influencing each other. In other embodiments, the influence score value may be different, such as where the time between the touch-end event of the palm touch 208 and the time of calculation is longer or shorter in time then the touch-end event of writing touch 206 and the time of calculation. A separate influence score may be measured between the writing touch 206 and each of the other palm touches, 210, 212, 214, 216, 218. Likewise, an influence score may be measured between palm touch 210 and each of the other touches 206, 208, 212, 214, 216, 218. It should be appreciated that a distinct influence score may be calculated between each point and every other point, such that each point will have a measured influence score as to all other points. Furthermore, it should also be appreciated that the influence scores may be calculated using any suitable equation, and the invention is not limited to just the expression provided above.

In various embodiments, an impact score component may be used to calculate an impact score for each touch point based on one or more of the determined influence scores for that touch point. In at least one embodiment, the impact score for a given touch point may be the sum of all influence scores for that touch point. In FIG. 2, each touch has a corresponding value associated and displayed with it; its impact score. For example, the writing touch 206 has a displayed impact score of 0.004. This value may be the sum of all influence scores between writing touch 206 and all other recognized touches 208, 210, 212, 214, 216, 218. Similarly, for example, palm touch 214 has an impact score of 0.401. The impact score of palm touch 214 may be the sum of all influence scores between itself and the other recognized touches 206, 208, 210, 212, 216, 218. As can be appreciated, an impact score may be calculated for each touch point in a similar fashion. While described as a sum of influence scores, the impact score may by any other mathematical combination of influence scores. The impact score may generally represent the total impact/influence of the other touches on a given touch point.

As seen in FIG. 2, the writing touch 206 has a considerably lower impact score than the rest of the recognized touches. This is supported, in this example, by the fact that the example equation used for calculating influence scores used distance as a factor. Similarly, palm touch 208 is more distant, relative to other palm touches, and therefore has a relatively low impact score, 0.103, compared to other palm touches, but a relatively large impact score when compared solely to writing touch 206. Conversely, palm touch 214, which has four recognized touches relatively close to it and on either side of it, has the highest displayed impact score, 0.401.

In various embodiments, the impact score may be used to find, or determine, which touch is the writing touch. For example, in various embodiments, the writing touch may be determined to be the touch with the lowest impact score. Conversely, the palm touches generally may be relatively close to each other and thus have a significantly higher impact score than the writing touch. However, because the writing tool is often and frequently lifted off the surface at times, such as to make a new handwriting stroke, the touch with the lowest impact score is not necessarily always the writing touch. Often, the palm may remain in contact with the multi-touch interface for a plurality of writing touch-based strokes. A general solution may recognize the life-span differences between a typical writing touch and a typical palm touch. Accordingly, palm touches may typically have longer touch-move events because they may generally represent a hand gliding across the surface. In such a scenario, writing touches may be easily identifiable as the short-lived touches with the lowest impact scores.

In a more particular embodiment, a threshold component may be used to distinguish one or more palm touches from a writing touch. In some embodiments, a threshold may be defined as a maximum impact score a touch may have and still be considered a writing touch. In one embodiment, the threshold may be pre-determined. In another embodiment, the threshold may be selected by the user. In still another embodiment, the threshold may be dynamic, thus automatically adjusting higher or lower as a user's writing style is learned and/or automatically adjusted based on any other factor.

As previously discussed, a touch may sometimes be referred to as a touch-based stroke, in some embodiments. In various embodiments, a touch-based stroke may be defined by, but is not limited in definition to, a touch-start event, a touch-move event, and a touch-end event. A touch-start event may represent the moment an object comes into contact with the multi-touch interface, thereby creating a touch. The touch-move event may track the touch as it moves across the surface of the multi-touch interface. In other embodiments, a touch may be substantially continuously tracked to create the touch-move event of the touch-based stroke. Any suitable method may be used to recognize a touch-move event. The touch-end event may represent the moment the object is removed from the surface of the multi-touch interface, thus ending the touch-based stroke.

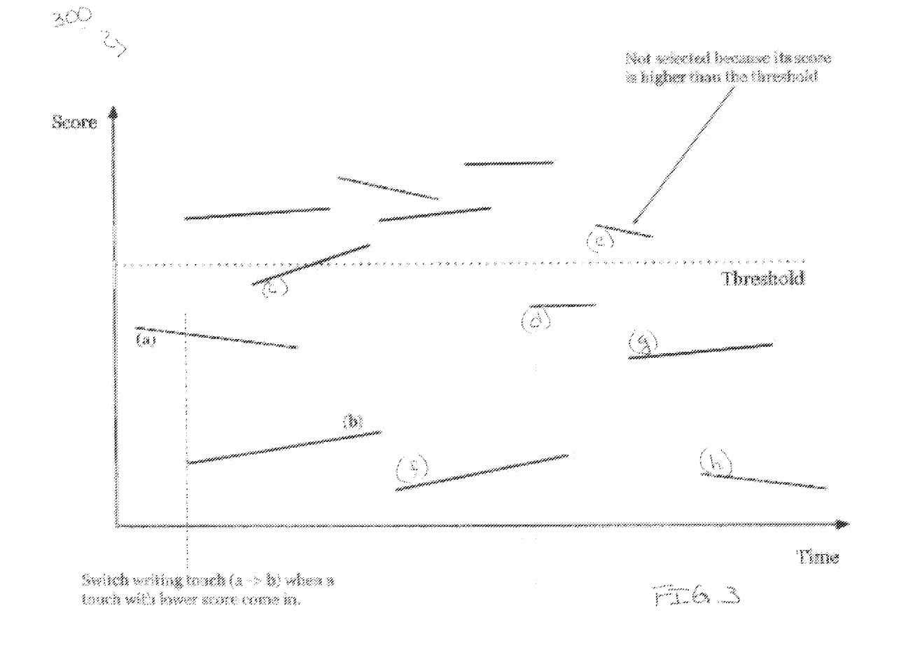

Referencing FIG. 3, a graph 300 represents the scores of touch-based strokes as represented over time. As indicated above, an influence score may be calculated at various times during a stroke, including but not limited to the moment the touch is registered, periodically after each stroke, during each stroke, at predetermined intervals, at the end of a touch, randomly, and/or other methods. Furthermore, an influence score may be calculated substantially continuously or sporadically. The scores for a given stroke may be connected and represented, for example, as a line in graph 300. A dotted line threshold 302, or maximum impact score, is illustrated to better demonstrate one or more effects of the threshold 302. In various embodiments, any touch-based stroke crossing or existing entirely above the threshold 302 may be recognized as a palm touch and thereby disregarded or ignored. On the other hand, a touch-based stroke below the threshold 302 may gain a presumption of being a writing touch, herein referred to interchangeably as “the presumption.” The presumption may be overcome, however, if another touch registers a lower impact score, at the same time or during the same time period.

For example, touch based stroke (a) is the first touch graphically represented. Because touch-based stroke (a) has an impact score below the threshold 302, it may initially be recognized as a writing touch. However, touch-based stroke (b), which started at a time subsequent to the start of touch-based stroke (a) but while touch-based stroke (a) was still occurring, has a noticeably lower impact score than touch-based stroke (a). Because touch-based stroke (b) starts before the touch-end event of touch-based stroke (a), the presumption as to which stroke is the writing touch shifts from touch-based stroke (a) to touch-based stroke (b). In various embodiments, any mark registered during any point of a touch-based stroke that, at some point, loses the presumption of being the writing touch may be disregarded and never recorded. That is, any mark made by touch-based stroke (a) may not become a visible marking to the user of the multi-touch screen and/or if a mark or stroke had begun to be displayed on the touch screen, it may be deleted or erased. Of course, in other embodiments, the registered marking made by touch-based stroke (a) may indeed be recorded, if desired. The recorded stroke (a) may be deleted when/if the stroke (a) loses its presumption of being the writing touch, while it is being registered, i.e.—before the strokes touch-end event, after the stroke ends, or at any other suitable time. In some embodiments, various editing tools may additionally be provided for a user to remove one or more unwanted markings.

After gaining the presumption of being the writing touch, and where no other touch having a lower impact score starts before stroke (b) ends, the handwriting stroke registered with touch-based stroke (b) may be recorded, thereby becoming visible to the user of the multi-touch interface. Because no other touch based strokes were registered before touch-based stroke (b)'s touch-end event, the handwriting stroke may, generally, be permanently recorded by the interface. In one embodiment, a stroke may be made visible while the stroke is drawn and may stay visible as long as it retains the presumption during its stroke lifetime. It should be appreciated that one or more tools may allow a user to nonetheless discard any unwanted markings, whether the markings were intentionally made or not.

As discussed, a touch-based stroke that has a touch-start event having an impact score below the threshold value 302 may gain the presumption of being the writing touch, assuming no other touches have a lower impact score in the relevant time period. However, if the touch-based stroke rises to and/or above the threshold 302 during the touch-move event, the presumption may be lost. For example, if touch-based strokes (a) and (b) were not present in FIG. 3, touch-based stroke (c) would gain the presumption, but because it passes over the threshold 302 during its life the presumption may be lost. In various embodiments, the registered touches of touch-based stroke (c) may be discarded or ignored. Similarly, a touch-based stroke that starts with an impact score above the threshold 302 but over its life has impact scores that register below the threshold 302 may, in some embodiments, not gain the presumption and would thus not be recorded. In other embodiments, such a touch-based stroke, or some portion thereof, may be recorded, if desired.

In the example illustrated in FIG. 3, touch-based stroke (f), having the lowest impact score under the threshold 302 and subsequent in time to stroke (b), may next gain the presumption. The registered touches of touch-based stroke (f) may thus be recorded in a similar fashion as stroke (b).

Similar to the analysis of touch-based strokes (a) and (b) above, but in reverse, touch-based stroke (d) may not be recorded as a writing touch, in some embodiments. While touch-based stroke (d) has an impact score under the threshold 302, and during at least part of its lifetime, it is the touch with the lowest impact score (i.e., after stroke (f) ends), the stroke begins before the touch-end event of touch-based stroke (f), and thus may not gain the presumption for any part of its stroke. In such an embodiment, touch-based stroke (d) may be completely ignored for the life of the stroke. More generally, in some embodiments, a touch-based stroke becoming the stroke with the lowest impact score during its lifetime, may not gain the presumption unless it has a touch-start event after, or simultaneously with, the touch-end event of another stroke having a lower impact score and most recently holding the presumption. Nonetheless, in other embodiments, touch-based stroke (d) may gain the presumption after the touch-end event of touch-based stroke (f), if desired.

Regardless of whether touch-based stroke (d) gains the presumption, touch-based stroke (e) may not gain the presumption for the time period between the touch-end event for touch-based stroke (d) and the touch-start event for touch-based stroke (g) because it is entirely above the threshold 302. On the other hand, touch-based stroke (g) may gain the presumption, as it has the next touch-start event after the touch-end event of (f), has the lowest registered impact score at its touch-start event, and is below the threshold 302. However, similar to (a) and (b), touch-based stroke (g) may lose its presumption to touch-based stroke (h), once touch-based stroke (h) begins, because touch-based stroke (h) has an even lower impact score. Thus, of all the example touch-based strokes shown in the embodiment of FIG. 3, in one embodiment, only touch-based strokes (b), (f), and (h) may be recognized as writing touches and thereby recorded, becoming thus visible to the user on the interface.

Still referencing FIG. 3, and as discussed above, the threshold 302 may change based on the user's writing style. As demonstrated in this example, more touch-based strokes fell below the threshold 302 than above it. Of the seven touch-based strokes that, at least partially, fell below the threshold 302, only three were recorded as writing touches: (b), (f), and (h). In some embodiments, the system could recognize that touch-based strokes comprising impact scores in a certain range are always found to be palm strokes and lower the threshold to incorporate these strokes. In this regard, computing power may be saved by disregarding or ignoring registered palm touches without having to compare them to other presumptive writing touches. For example, the threshold 302 may be lowered to a point somewhere below the impact scores of touch-based stroke (d), perhaps even to encompass the portion of (a) with the highest impact score. In such a scenario, only touch-based strokes (b), (f), (g), and (h) would ever gain the presumption. It should be understood that embodiments having an automatically adjusting threshold 302 may adjust the threshold up or down in any increment, and at any time.

Regardless of the threshold value, there may be registered palm touches that are falsely recognized as writing touches because they register impact scores below the threshold and have touch lifespans that start after the last true writing touch and end before another true writing touch begins. For example, and in reference to FIG. 4, the palm touch-based stroke (k) may be falsely recognized as a writing touch, in some embodiments. Similar to the analysis done above, touch-based strokes (i), (j), (m), and (n) may be recognized as writing touches and thus recorded. As discussed, touch-based stroke (k) may be a palm touch, as its impact score is clearly higher than touch-based stroke (u) and (v) which have already been determined as palm touches. However, touch-based stroke (k) may be recognized as a writing touch as its impact score is below the threshold, its touch-start event begins after the touch-end event of (j), and its touch-end event is before the touch-start event of (m). Thus, some palm touches, especially short lived touches, may be recognized as writing touches and therein recorded.

Accordingly, in various embodiments, a distance comparison component may be used to correct for touch-based strokes that are falsely recognized as writing touches. The distance comparison component may use one or more logical equations using information obtained by the system and/or about the touches in order to determine whether a recognized writing touch is correctly identified or not. In some embodiments, the distance between the touches may be used to determine whether a touch is correctly identified.

In one particular embodiment, the distance comparison component may use the following logic equation to make a determination as to whether a touch is a palm touch:

(distance(k,m)>N*distance (j,m))̂(score(k)>score (m)+α)→k is α palm touch

where k represents touch-based stroke (k), m represents touch-based stroke (m), and j represents touch-based stroke (j); distance (k,m) is the distance between touch-based stroke (k) and touch-based stroke (m), distance (j,m) is the distance between touch-based stroke (j) and touch-based stroke (m); N is a multiplying variable; score(k) and score (m) are the impact scores for touch-based stroke (k) and touch-based stroke (m), respectively; and a is a variable. The above equation may read “if the distance from ‘k’ to ‘m’ is more than ‘N’ times greater than the distance from ‘j’ to ‘m’ and the impact score of ‘k’ is greater than the impact score of ‘m’ by an amount of ‘α,’ then ‘k’ is a palm touch.” The distance between two touch-based strokes may be determined according to any suitable algorithm. In one embodiment, it may be the distance between a point along one of the strokes to a point along the other stroke. For example, in various embodiments, the distance from one touch-based stroke to another touch-based stroke may be the shortest distance between the two strokes, the farthest distance between the two touch-based strokes, an average distance between the two-touch based strokes, or any other suitable distance. In some embodiments, α may be a predetermined constant. In other embodiments, α may be a dynamic variable. It should be understood that α may represent any suitable value. In various embodiments, ‘N’ may be a predetermined constant. In other embodiments, ‘N’ may be changed by the user, be dynamic, and/or change with the user's writing style. In one embodiment, for example and example purposes only, N may equal “3.” Thus, the above equation would read “if the distance from ‘k’ to ‘m’ is more than three times greater than the distance from ‘j’ to ‘m’ and the impact score of ‘k’ is greater than the impact score of ‘m’ by an amount of ‘α,’ then ‘k’ is a palm touch.” The distance variable of N may be any suitable value and, may be more than, less than, or equal to three. Thus, some touch-based strokes having an impact score less than the threshold and initially possessing the presumption may correctly designate a falsely identified writing touch as a palm touch. Accordingly, any touch-based stroke that is initially presumed to be a writing touch, but found to be a palm touch using the distance comparison component may be discarded or ignored, in various embodiments.

In some embodiments, and under certain circumstances, the logic of the above distance comparison component may be less valuable. For example, as a user's handwriting moves across the multi-touch interface it may eventually reach an edge and have to move to a new line. The distance from the writing touch on the new line to the last writing touch may be quite large. Thus, the touch-based stroke that should be designated a palm touch may remain falsely identified as a writing touch. In various embodiments, the distance comparison component may be capable of accounting for this problem. For example, part of the comparison or determination may include an analysis of how close the touch is to an edge and whether the next registered writing touch is near the same edge, or located closer to another edge of the multi-touch interface. It should be appreciated that any suitable means to determine whether a touch is a palm touch or a writing touch may be used.

A writing style component may additionally or alternatively be used, in some embodiments, to determine which touch is the writing touch. In some circumstances, a palm touch may have a lower score than the writing touch. Depending on positioning and writing style it is possible that a palm may only cause one or two touches, or additionally or alternatively, one or more palm touches may be spaced far away from each other. For example, a user's wrist may touch the screen, another finger or hand may touch the screen, and/or any other person, writing tool, or object may make one or more touches. In such cases, sometimes one or more palm touch(es) may end up with a lower impact score than the writing touch. In various embodiments, the writing style component may correct this problem by adjusting the score based on the writing style of the user.

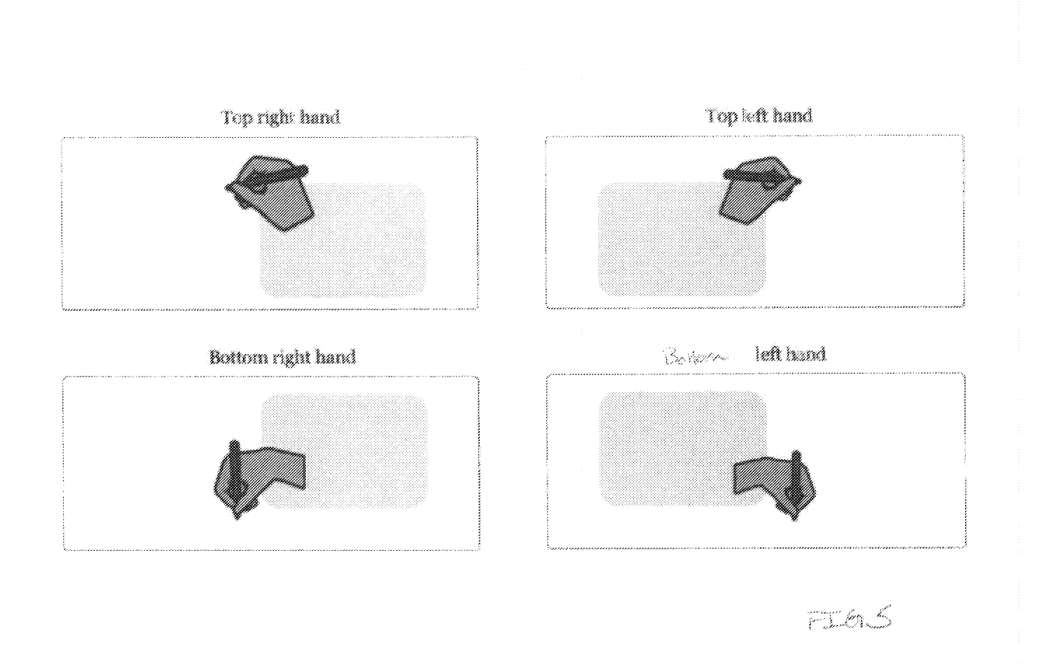

In various embodiments, there may be one or more recognized writing styles from which to select. In one embodiment, the writing styles may include, but are not limited to, a top right hand style, a top left hand style, a bottom right hand style, and a bottom left hand style. In other embodiments, there may additionally or alternatively be a middle right hand style and a middle left hand style. In still other embodiments, any number of different writing styles may additionally or alternatively be used. As seen in FIG. 5, a top hand style may refer to a style where the users writing tool is generally placed above or superior to the user's palm on the writing surface. A bottom hand style may refer to a style where the users writing tool is generally placed below or inferior to the user's palm on the writing surface. A bottom hand style may also be referred to as a hook style. A middle hand style, as used herein, may refer to a style where the users writing tool is generally in a position somewhere between a top hand style and a bottom hand style. A right hand style may generally refer to a style where the user writes with their right hand, and therefore the writing tool may generally be located to the left of the palm. A left hand style may generally refer to a style where the user writes with their left hand, and therefore the writing tool may generally be located to the right of the palm.

In at least one embodiment, the writing touch may be identified based on a the user's writing style. For example, when writing with a top right hand style the writing touch may be above and to the left relative to the palm touches. The touch that is farthest left and above the other touches may be recognized as the writing touch. In another example, a left handed hook or bottom style may cause the writing touch to be lower and to the right of the palm touches. The touch that is farthest to the right and below other touches may be recognized as the writing touch. While relatively easy to implement, using this method may have inherent limitations and therefore, in various embodiments, additional or alternative methods to identify the writing touch and/or discard the palm touches may be implemented, as discussed above.

Specifically, for example, a given hand writing style may be used to increase the impact scores of one or more touches that may be palm touches, thereby more easily identifying them as palm touches instead of writing touches. Any suitable mathematical function may be used to increase a touch's respective impact score based on its position on the screen and/or the direction the touch moves on the screen while writing and the mathematical functions may vary among the writing styles. In one particular example, the following function, which may be particularly beneficial for the top right hand style but may also be applicable to other styles, may be used to evaluate and/or adjust each touch:

f(x,y)=(x/width)*α+(y/height)*β

where x and y may, respectively, represent the coordinates of the touch along the x-axis and y-axis of the multi-touch interface's screen, i.e., the touches location on the screen; width is the latitudinal dimension of the multi-touch interface screen; height is the longitudinal dimension of the multi-touch interface screen; α is a constant having a value; and β is also a constant having a value. In some embodiments, the α and β of the above function may be the same constants as other functions disclosed herein. In other embodiments, α and/or β may represent a different unique value. In some embodiments, α and/or β may be chosen based on experiments. In some embodiments, α and/or β may be pre-determined for each writing style. In other embodiments, α and/or β may be dynamic, thereby adjusting to a writing style as the user writes. In still other embodiments, α and/or β may be selectable by the user.

In various embodiments, the writing style may be selected or indicated by the writer. In such circumstances, the above equation may more quickly and accurately adjust influence and impact scores based on whether a touch is recognized as a writing touch or a palm touch. However, the writing style component may use data from the user's writing to additionally or alternatively identify a user's hand writing style. One or more writing style vectors may be used to identify the user's handwriting style. In some embodiments, a writing style vector may point from a palm touch to a writing touch, where each palm touch point having a relatively higher impact score may be the base of the arrow and the arrow may point towards the writing touch, or touch having the lowest impact score. In various embodiments, the magnitude of the writing style vector may be, or be related to, the difference between the impact score of the palm touch and the writing touch, such that the greater the difference between the impact score of the palm touch and the writing touch, the greater the magnitude of the writing style vector. A higher magnitude may indicate a greater confidence or likelihood that the vector correctly points from a palm touch to a writing touch. Conversely, a lower magnitude of a writing style vector may indicate a lesser confidence the vector points from the palm touch(es) to the writing touch.

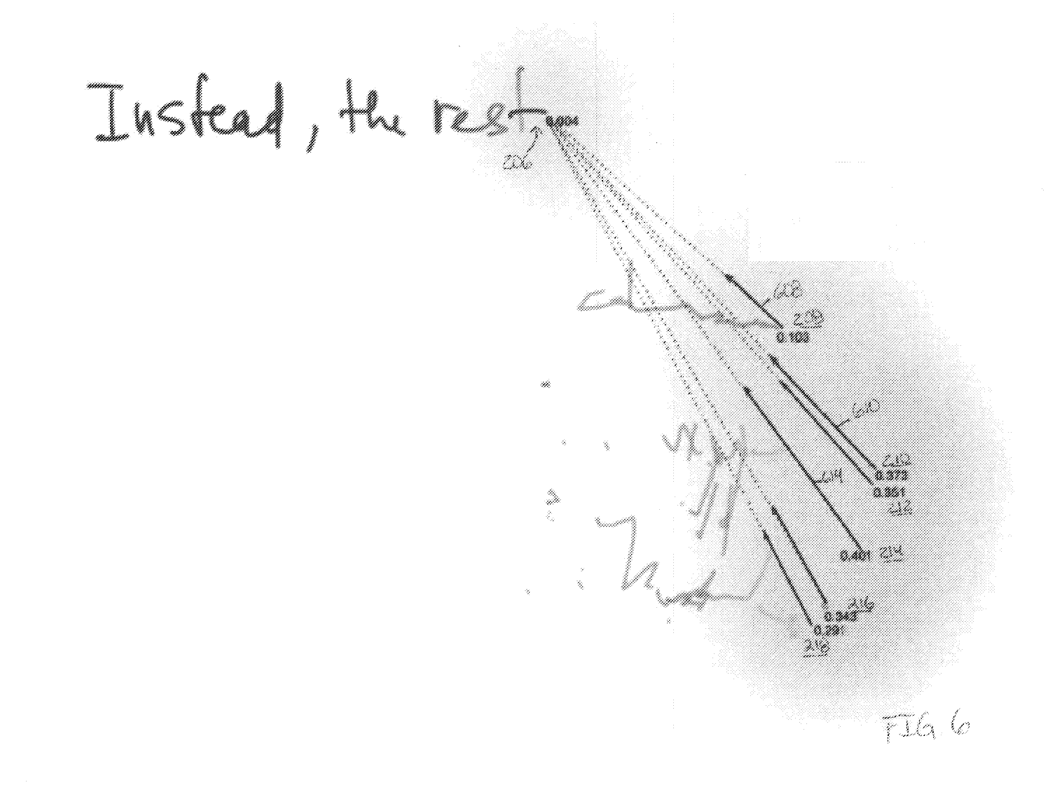

Referencing FIG. 6, the multi-touch interface 200 shows the example handwriting 202, previously seen in FIG. 2. A writing style vector 608 may point from palm touch 208 to the writing touch 206. The magnitude, or length, of the writing style vector 608 may be relative to the difference between the impact score of the palm touch 208, which is shown as 0.103, and the impact score of the writing touch 206, shown to be 0.004. The greater the difference in the two impact scores, the greater the magnitude of the writing style vector. For example, the writing style vector 614 may point from palm touch 214 to the writing touch 206. The magnitude of the writing style vector 614 may be relatively greater than the magnitude of writing style vector 608 due to the difference between the impact score of the palm touch 214, which is shown as 0.401, and the writing touch. Because the difference between impact scores for palm touch 214 and the writing touch 206 is greater, the magnitude is shown to be noticeably larger. In some embodiments, the magnitude of a writing style vector may be the difference between the impact scores of the two touches. That is, the magnitude of vector 608 would be 0.099; or 0.103 minus 0.004. In other embodiments, the magnitude may be more loosely based on the difference between impact scores. For example, the two impact scores from the respective touches may be used in a function or equation to determine a magnitude. Any suitable method to determine a magnitude of a writing style vector may be used.

One or more writing style vectors may be used to determine a writing style confidence vector. In one embodiment, the sum of the one or more writing style vectors, measuring their magnitude and/or direction, may create a writing style confidence vector. In various embodiments, the writing style confidence vector may be a single vector, having a given direction and magnitude. The direction of the writing style confidence vector may generally show the relationship of the palm touches to the writing touch. That is, if the writing style confidence vector has a direction pointing to the upper left it may indicate the palm is to the right of the writing tool and the writing tool is generally used at the top of the palm or hand. Therefore, a top right hand style may be assumed. Conversely, if the writing style confidence vector has a general direction of straight right it may indicate the palm is directly to the left of the writing tool. Therefore, a middle left hand style may be assumed. Likewise, a writing style confidence vector having a direction to the upper right may indicate a top left hand style, a direction to the lower left may indicate a bottom right style, and a direction to the lower right may indicate a bottom left style. It may be appreciated that the writing style confidence vector may indicate any number of different writing styles.

In various embodiments, a single writing style confidence vector may be used to indicate a given writing style. Additionally or alternatively, one or more analyzed writing style confidence vectors from various points in time may be used in conjunction with one another to determine a writing style. For example, an average of two or more of such writing style confidence vectors, such as but not limited to, the last ten writing style vectors, may be used to indicate the user's writing style. In this manner, one or more users with different writing styles may use the same multi-touch writing surface and their respective hand writing styles may quickly be identified and adjusted to better identify the writing touch for each style. It may be understood that an average of any number of recent writing style confidence vectors may be used to indicate the current user's writing style. In various embodiments, an average of ten, less than ten, or more than ten recent writing style confidence vectors may be used.

While the discussion herein is directed in part to one or more example algorithms, it may be recognized that the algorithms are based generally on giving one or more touches an identifying score. Therefore other information may be integrated into one or more of the algorithms and is therefore within the scope of the current disclosure. In some embodiment, the velocity at which a touch, or touch-based stroke, moves across the screen may be additionally or alternatively used to identify the writing touch. For example, while the palm may generally rest on the multi-touch surface in a static fashion, moving only slightly as a hand moves across the surface, the writing tool and touch may make quick strokes as it constructs one or more words, letters, symbols, etc. In some embodiments, the direction in which a touch-based stroke moves may be additionally or alternatively used to identify the writing touch. For example, while the palm may move across the multi-touch surface in generally one direction as a user writes, the writing touch may generally more often make more varied movements including but not limited to, moving left-to-right, right-to-left, up and down, circular or semi-circular, any other type of movement, or any combination thereof as it is used to compose various letters, numbers, and symbols. In addition, recognition of other moving patterns of touches may be used to identify the writing touch and/or palm touches. One non-limiting example may include the use of periods, which may be very short touch-based strokes. One or more period touch-based strokes may be used to get an average or likely distance from the writing touch to the one or more palm touches.

In addition, the writing direction may additionally or alternatively be used to predict where the next writing touch may be, based on the previous writing touch. In some embodiments, recognized writing directions may include, but are not limited to, left to right, top to bottom, right to left, or any other writing direction. In some embodiments, the recognized writing direction may be used to give an increased presumption of being a writing touch based on the anticipated movement. In some embodiments, the recognized writing direction may additionally or alternatively be used to give a writing touch a lower score, which may in-turn lead to a greater likelihood of identifying the correct writing touch.

Furthermore, the pressure exerted by each touch on the multi-touch interface may also be used to differentiate between a writing touch and a palm touch. In various embodiments, a pressure detection device, such as a gyroscope, may be used to detect the pressure exerted. In some embodiments, a writing touch may generally press harder on the surface of the multi-touch interface. Thus, a touch with a relatively harder exerting force may have an increased presumption of being the writing touch. The touch with a relatively harder exerting force may additionally or alternatively be used to lower the influence or impact scores associated with that touch. In contrast, other embodiments may recognize the palm touch as exerting more force. In such embodiments, there may be a pressure threshold that limits the presumption to touches with an exerted pressure less than the threshold. Additionally or alternatively, in such embodiments, as the pressure associated with a touch increases it may instead cause the impact score associated with the touch to increase.

While discussed as separate components herein, it is recognized that in other embodiments, any of the components or modules described herein, in any combination, may be combined as a single module or multiple modules in different configurations than described herein. Any additional modules, components, or functionality may further be included. Likewise, not every module or component described herein is required in every embodiment.

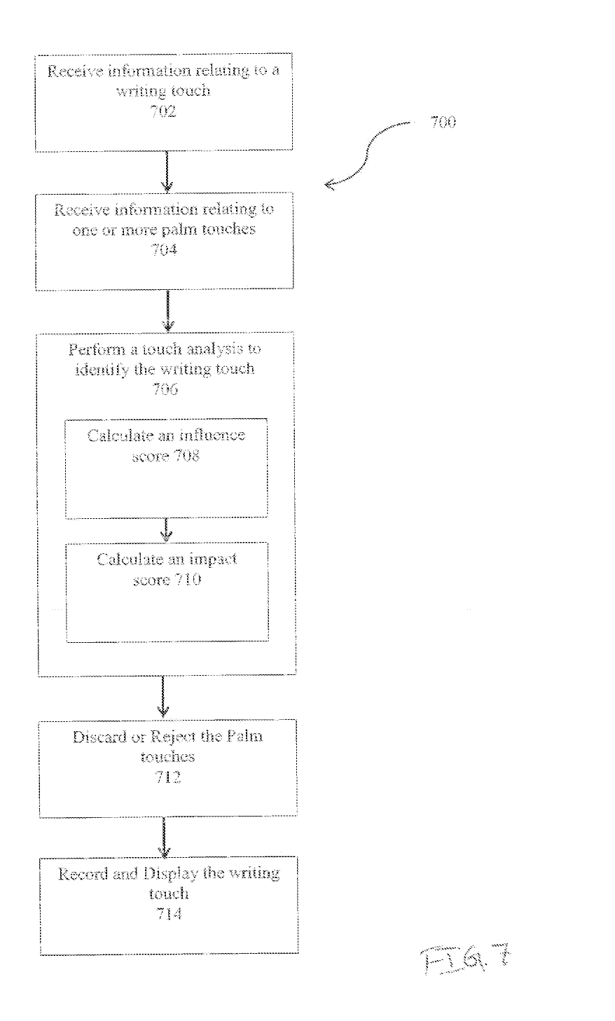

Referencing FIG. 7, a method 700, according to one embodiment, for identifying the writing touch is illustrated. The multi-touch screen may receive information relating to a writing touch 702. The multi-touch screen may also receive information relating to one or more palm touches 704. While illustrated diagrammatically as occurring in an order where information relating to a writing touch is received prior to information relating to one or more palm touches, it is understood that information relating to a writing touch could be received after information relating to one or more palm touches, substantially simultaneously with information relating to one or more palm touches, or in any other order or combination thereof. The multi-touch interface may perform a touch analysis 706 in order to identify or distinguish between the writing touch and the one or more palm touches. The touch analysis 706 may include calculating an influence score 708, such as or similar to the calculation of the influence score discussed herein. The touch analysis 706 may also include calculating an impact score 710, such as or similar to the calculation of the impact score discussed herein. The multi-touch interface may then discard or reject the palm touches 712 as well as record and/or display the writing touch 714 on the multi-touch screen.

In the foregoing description various embodiments of the present disclosure have been presented for the purpose of illustration and description. They are not intended to be exhaustive or to limit the invention to the precise form disclosed. Obvious modifications or variations are possible in light of the above teachings. The various embodiments were chosen and described to provide the best illustration of the principals of the disclosure and their practical application, and to enable one of ordinary skill in the art to utilize the various embodiments with various modifications as are suited to the particular use contemplated. All such modifications and variations are within the scope of the present disclosure as determined by the appended claims when interpreted in accordance with the breadth they are fairly, legally, and equitably entitled.

We claim:

1. A method for detecting touches on a multi-touch interface, the method comprising:
receiving information relating to a first touch and receiving information relating to one or more other touches through a touch-based display screen;
performing a touch analysis, the touch analysis being a comparison of the first touch as compared to the one or more other touches in order to determine a writing touch and one or more non-writing touches, the touch analysis comprising determining a distance-based influence score between the first touch and each of the one or more other touches.

2. The method of claim 1, wherein each touch comprises a touch-start event, a touch-move event, and a touch-end event, wherein the touch-start event relates to a point of first contact of the touch with the touch-based display screen, the touch-move event relates to a path of movement of the touch while it remains in contact with the touch-based display screen, and the touch-end event relates to a last point of contact of the touch before losing contact with the touch-based display screen.

3. The method of claim 2, wherein the influence score between the first touch and each of the one or more other touches is determined from the following expression:
f(d, t)=(1−min(d, dₘₐₓ)/dₘₐₓ)²*(1−min(t, tₘₐₓ)/tₘₐₓ)²
where d is the distance from the respective other touch to the location of the first touch, dₘₐₓ is the maximum distance within which the respective other touch may have an influence on the first touch, t is the time since the respective other touch ended; and tₘₐₓ is the maximum time that the respective other touch may influence other touches after it has ended.

4. The method of claim 3, wherein dₘₐₓ is a predetermined value.

5. The method of claim 4, wherein tₘₐₓ is a predetermined value.

6. The method of claim 3, wherein the influence score for the first touch is determined, at least one of: at the touch-start event; at the touch-end event; or at least once during the touch-move event.

7. The method of claim 6, wherein the influence score for the first touch is determined periodically during the touch-move event.

8. The method of claim 1, wherein the touch analysis further comprises determining an impact score for the first touch, the impact score based on the one or more influence scores of the first touch.

9. The method of claim 1, wherein the touch analysis comprises determining, for each touch, a distance-based influence score between that touch and each of the other touches.

10. The method of claim 9, wherein the touch analysis further comprises determining an impact score for each touch, the impact score based on the one or more influence scores of the respective touch.

11. The method of claim 10, wherein the impact score for each touch comprises a sum of the one or more influence scores determined for that touch.

12. The method of claim 11, wherein the touch analysis determines the writing touch and one or more non-writing touches based on the impact scores of the touches.

13. The method of claim 12, wherein the touch analysis determines the writing touch to be the touch with the lowest impact score.

14. The method of claim 12, wherein the touch analysis further comprises a threshold value, where touches with an impact score on one side of the threshold cannot be considered a writing touch irrespective of a comparison of their impact scores to the impact scores of other touches.

15. The method of claim 9, wherein an impact score for a touch is modified based on at least one of a position of the touch on the touch-based display screen and a direction of movement of the touch on the touch-based display screen.

16. The method of claim 12, wherein the touch analysis further comprises determining, for each of the non-writing touches, a vector with a direction toward the writing touch and a magnitude based on a comparison of that touch's impact score and the impact score of the writing touch.

17. The method of claim 16, wherein the magnitude of a vector for each non-writing touch is based on the difference between the impact score of the respective non-writing touch and the impact score of the writing touch.

18. The method of claim 17, wherein the touch analysis further determines a writing style confidence vector based on a mathematical combination of the vectors for each non-writing touch.

19. The method of claim 18, wherein the writing style confidence vector indicates a given writing style.

20. The method of claim 19, wherein the touch analysis re-determines the writing touch and one or more non-writing touches based on the writing style confidence vector.
